(19) United States
(12) Patent Application Publication
(10) Pub. No.: US 2010/0285418 A1
(43) Pub. Date: Nov. 11, 2010

(54) ORTHODONTIC LIGATURE SYSTEMS AND METHODS

(76) Inventors: William Stuart Trimmer, Hillsborough, NJ (US); Robert Steven Sears, Round Hill, VA (US)

Correspondence Address: NIXON & VANDERHYE, PC, 901 NORTH GLEBE ROAD, 11TH FLOOR, ARLINGTON, VA, 22203, US

(21) Appl. No.: 12/067,384

(22) PCT Filed: Sep. 25, 2006
(86) PCT No.: PCT/US06/37364

§ 371 Date: Jul. 16, 2010

Related U.S. Application Data
(60) Provisional application No. 60/721,487, filed on Sep. 29, 2005.

(51) Int. Cl. A61C 7/28; A61C 7/02

(52) U.S. Cl. 433/3; 433/10; 433/24

(57) ABSTRACT

Ligature systems retain an arch wire within a slot of an orthodontic bracket. According to some embodiment, the ligature system retains an arch wire within a slot of an orthodontic bracket by means of a retaining element which is capable of being unidirectionally mechanically locked within the slot of the orthodontic bracket to retain an arch wire therewithin. The retaining element may comprise a pair of opposed outwardly projecting retaining edges. In some embodiments, the retaining element comprises a planar or curved retaining plate. The ligature system may include a central block in which the retaining plate is embedded such that the retaining edges extend outwardly therefrom. The ligature system may also include spike protruding outwardly from such central block so as to engage with the arch wire positioned subjacently thereto. In some embodiments of the invention, the retaining element is integral with the arch wire, while in other embodiments of the invention, the retaining element is integral with the slot in the orthodontic bracket. A dispenser may also provided according to the invention for dispensing individual ligature systems.

### CROSS-REFERENCE TO RELATED APPLICATION

This application is based on, and claims priority benefits from, U.S. Provisional Application Ser. No. 60/721,487 filed on Sep. 29, 2005, the entire content of which is expressly incorporated hereinto by reference.

### FIELD OF THE INVENTION

The present invention relates generally to the field of orthodontics. In especially preferred embodiments, the present invention relates to ligature systems and methods for use with orthodontic brackets so as to removable secure arch wires thereto.

### BACKGROUND AND SUMMARY OF THE INVENTION

Orthodontic brackets move teeth by transmitting a force from an arch wire (or other external device) to one or more teeth. Typically the bracket is bonded to a tooth and an arch wire is inserted into a slot in the bracket. A ligature is then used to attach the arch wire to the bracket. Bends in the arch wire, or other external devices, generate forces in the arch wire which are transmitted to the bracket and then down into the tooth.

The bottom of a conventional bracket is typically bonded to the external surface of a patient's tooth. An arch wire is then placed in the central slot of the bracket. A conventional bracket will also include pairs of tie wings protruding laterally from the central slot. A ligature is therefore typically wrapped around the tie wings so as to mechanically capture and retain the arch wire within the slot.

There are several ligature systems currently employed in the art. One conventional ligature system includes elastic bands (electrometric force modules) which may be elastically wrapped around the tie wings and over the arch wire in the central slot. Steel ligation wires are also employed and may be wrapped around the tie wings in a manner similar to the elastic bands. Mechanical latching systems having a retaining arm which is capable of being moved between opened and closed conditions relative to the central bracket slot are also known. When the retaining arm is in its opened condition, an arch wire may be inserted into the slot. Subsequently, the retaining arm may be moved to its closed condition to mechanically capture the arch wire physically within the slot.

There are several difficulties with the currently known ligature systems. For example, they tend to be relatively large and cumbersome making it visually apparent that the patient is wearing orthodontic appliances. Conventional ligature systems also require substantial time to tie the arch wire to the individual bracket. Furthermore, with contemporary orthodontic ligature systems, there is great difficulty in controlling the friction between the ligature and arch wire. While mechanical latching systems with moveable retaining arms can make it easier for arch wires to be positioned within the bracket slots, they tend to be expensive. In addition, the current mechanical latching systems obscure the side of the bracket, making it difficult for the clinicians to adjust and keep the region clean.

It would therefore be desirable if an orthodontic ligature system could be provided with addresses many, if not all, of the problems noted above. It is towards providing such a ligature system that the present invention is directed.

Broadly, the present invention is embodied in ligature systems to retain an arch wire within a slot of an orthodontic bracket. In some embodiments of the invention, the ligature system retains an arch wire within a slot of an orthodontic bracket by means of a retaining element which is capable of being unidirectionally mechanically locked within the slot of the orthodontic bracket to retain an arch wire therewithin. The retaining element may comprise a pair of opposed outwardly projecting retaining edges. The retaining element may be a planar plate which is curved upon being forcibly positioned within the slot of a bracket, or may be initially curved prior to such forcible positioning within the bracket slot.

According to one embodiment of the present invention, the ligature system will include a central block in which the retaining plate is embedded such that the retaining edges extend outwardly therefrom. The ligature system may include spike protruding outwardly from such central block so as to engage with the arch wire positioned subjacently thereto.

In some embodiments of the invention, the retaining element is integral with the arch wire, while in other embodiments of the invention, the retaining element is integral with the slot in the orthodontic bracket.

A dispenser is also provided according to the invention for dispensing individual ligature systems. In preferred embodiments, the dispenser includes an elongate dispenser tube and a stack of individual ligature systems within the dispenser tube. Each of the individual ligature systems most preferably comprise a central block, and a pair of retaining edges outwardly and upwardly extending from opposite sides of the central block. A plunger may be operated so as to exert pressure on an uppermost one of the individual ligature systems in the stack within the dispenser tube to cause a lowermost one of the individual ligature systems to be expelled from the dispenser tube and into a slot of an orthodontic bracket.

An arch wire may therefore be secured within a slot of an orthodontic bracket according to the present invention by forcing a ligature system as described hereinbelow into the slot of the orthodontic bracket in which the arch wire is positioned and allowing the ligature system to be unidirectionally locked within the slot so as to retain the arch wire therein. The ligature system may be aligned with the slot by use of the dispenser in which a stack of individual ligature systems are provided. An individual one of the ligature systems may thus be dispensed from the dispenser into the slot. In this regard, the individual ligature systems may be dispensed by the application of downward pressure to an uppermost one of the individual ligature systems in the dispenser sufficient to cause a lowermost one of the individual ligature systems in the dispenser to be dispensed therefrom into the slot.

These and other aspects and advantages will become more apparent after careful consideration is given to the following detailed description of the preferred exemplary embodiments thereof.

### BRIEF DESCRIPTION OF THE ACCOMPANYING DRAWINGS

Reference will hereinafter be made to the accompanying drawings, wherein like reference numerals throughout the various FIGURES denote like structural elements, and wherein;

FIG. 1a is a schematic perspective view of an exemplary ligature system in accordance with one embodiment of the present invention;

FIG. 1b is a cross-sectional elevation view of the ligature system depicted in FIG. 1a as taken along line 1b-1b therein;

FIG. 2 is a cross-sectional elevation view of an exemplary ligature system similar to FIG. 1b, but depicting an initially planar retaining plate;

FIG. 3 is a schematic perspective view showing a ligature system in accordance with the present invention positioned within central slots of a conventional orthodontic bracket so as to retain an arch wire therein;

FIGS. 4a and 4b are a schematic cross-sectional views of a dispenser that may be employed to dispense and position ligature systems of the present invention;

FIGS. 5-8 are side elevation views which respectively depict alternative embodiments of ligature systems in accordance with the present invention;

FIG. 9 is schematic perspective view which depicts yet another embodiment of a ligature system in accordance with the present invention; and

FIGS. 10-11 are side elevation views which depict additional embodiments of ligature systems in accordance with the present invention.

### DETAILED DESCRIPTION OF THE INVENTION

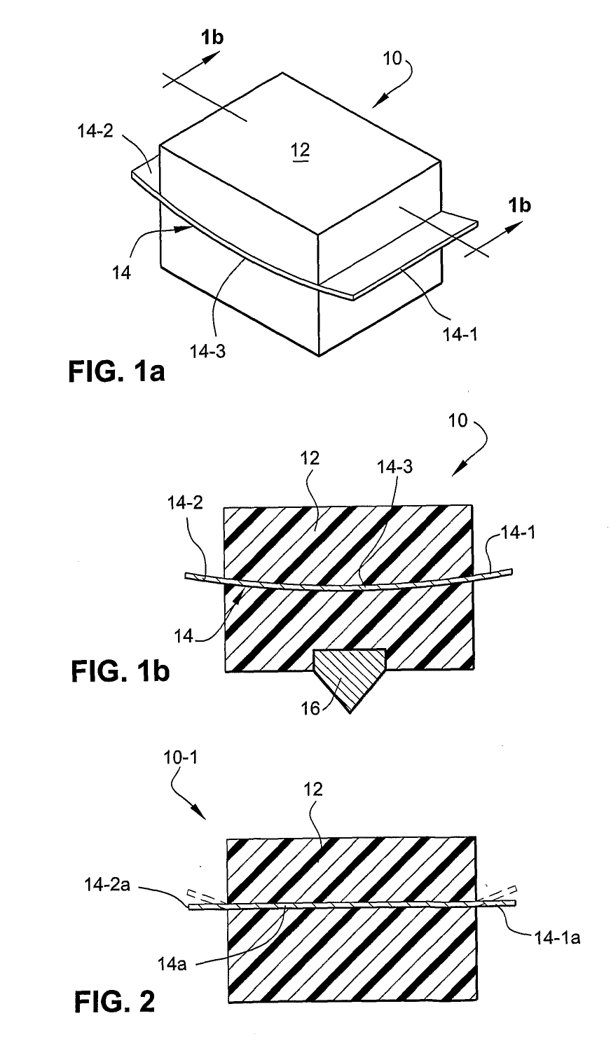

An exemplary ligature system 10 in accordance with the present invention is depicted schematically in accompanying FIGS. 1a and 1b. As shown, the ligature system 10 is generally comprised of a central block 12 in which a retaining plate 14 is embedded. The retaining block may be formed of virtually any material, but a rigid or semi-rigid plastics material (e.g., nylon) is preferred. The retaining plate 14 is most preferably a curved plate formed of a metal or plastics material. The curvature of the retaining plate 14, as viewed from above, is concave. As such, the terminal retaining edges 14-1, 14-2 of the retaining plate 14 extend outwardly and upwardly from the central block 12 so as to terminate at a position which is vertically above the embedded central region 14-3 of the retaining plate 14 within the central block 12. As viewed in end elevation (see FIG. 1b), the terminal retaining edges 14-1, 14-2 of the retaining plate 14 are oriented upwardly. A spike 16 may optionally be provided so as to protrude outwardly from a bottom surface of the central block 12. As is perhaps best seen in FIG. 3, the spike 16 may serve to contact an arch wire AW so as to preclude its movement in a lengthwise direction (i.e., movement generally along the direction of the wire) within the slot S of the orthodontic bracket B.

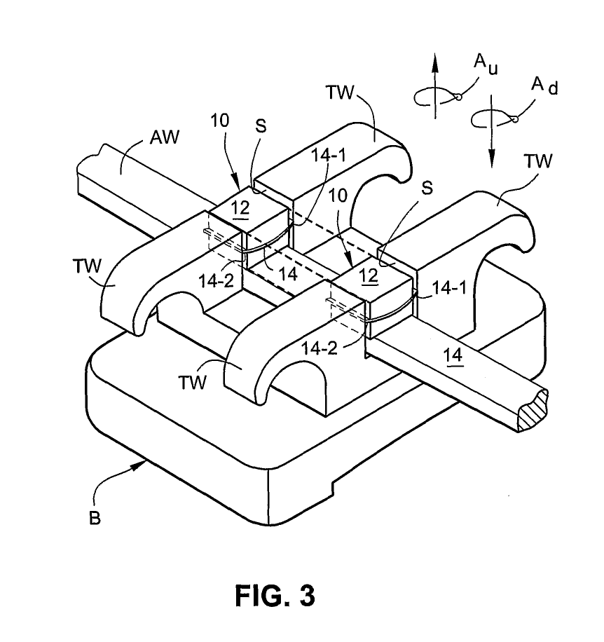

It is possible, however, for the retaining plate 14 to be formed as a planar element in which case its curvature as shown in FIGS. 1a and 1b above is induced in response to being forcibly positioned within the slot S of the bracket B (see FIG. 3). Such a planar retaining plate 14a is shown by solid line in accompanying FIG. 2 as having opposed planar terminal edges 14-1a, 14-2a. As shown in dashed line in FIG. 2, the terminal edges 14-1a, 14-2a may be deflected upwardly and outwardly as in response to their being forcibly abutted against the side walls of a bracket slot S. Such an embodiment may be advantageous in that the resilient unidirectional locking force exerted against the side walls of the bracket B may be increased by such induced curvature of the retaining plate 14a. The ligature system 10-1 depicted in FIG. 2 also does not have the optional spike 16 protruding outwardly therefrom as described above.

As is shown in FIG. 3, the curvature of the retaining plate 14, whether formed initially per the embodiment of FIG. 1 or induced per the embodiment of FIG. 2, imparts unidirectional mechanical locking of the ligature system 10 within a slot S of a conventional orthodontic bracket B. More specifically, accompanying FIG. 3 shows a pair of ligature systems 10 of the present invention positioned within central slots S of a conventional orthodontic bracket B so as to retain the arch wire AW therein. As shown, each ligature system 10 is positioned within a respective one of the slots S of the bracket B such that the upwardly oriented retaining edges 14-1, 14-2 engage the lateral sides of the slot S. However, as shown by the dashed lines in FIG. 3, it is entirely possible for a single ligature system 10 to be provided with a lengthwise dimension sufficient to be positioned along an upper surface of the arch wire AW and span both of the slots S.

By virtue of such upward orientation of the retaining edges 14-1, 14-2, a tight friction fit with the sides of the slot S will ensue to prevent the ligature system 10 from being withdrawn therefrom. That is, an upward force (arrow Aᵤ in FIG. 3) applied to the ligature system will be in a direction which is generally opposite to the curvature of the retaining plate 14 thereby causing the retaining edges 14-1, 14-2 to expand laterally and frictionally bite into the sides of the slot S. Conversely, a downward force (arrow A_{d} in FIG. 3) will be in a direction that is coincident with the curvature of the retaining plate 14. As such, a downward force will allow the retaining edges 14-1, 14-2 to contract laterally and thereby be moved downwardly along the sides of the slot S. As such, the entire ligature system 10 may be forced deeper into the slot S by a downward force to thereby positionally capture the arch wire AW therein.

When a clinician desires to remove the ligature system, a fork-like implement may be used to apply upward pressure locally to each of the terminal retaining edges 14-1, 14-2 so as to cause them to be inwardly flexed to allow upward movement of the ligature system 10. While maintaining such localized upward pressure, the ligature system 10 may be removed physically from the slot S of bracket B.

The ligature system 10 of the present invention achieves several beneficial results. For example, the unidirectional mechanical locking of the ligature system 10 permits it to be simply forced downwardly into the slot S of the orthodontic bracket B thereby saving the clinician substantial time. In addition, since conventional ligature bands will no longer necessarily need to be engaged with the tie wings TW of the bracket B, they may be omitted entirely thereby making the bracket smaller and less visible when bonded to a patient's teeth. Thus, even though such tie wings TW are depicted in the accompanying FIGURES, it will be understood by those skilled in this art that such structures are unnecessary to the proper functioning of the present invention.

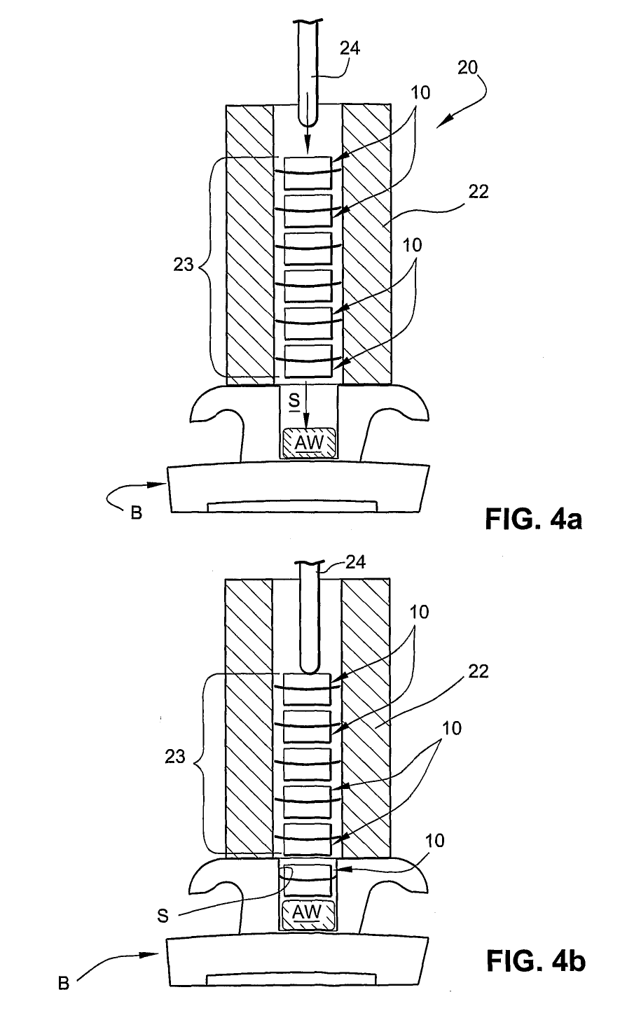

One possible dispenser 20 which would allow a clinician to dispense individual ligature systems 10 is shown in FIGS. 4a and 4b. In this regard, it will be observed that the dispenser 20 includes an elongate dispenser tube 22 which holds a stack 23 of ligature systems 10. A dispensing plunger 24 engages the top of the stack 23 of ligature systems 10. A clinician may therefore position the lower end of the dispenser 20 over a slot S of an orthodontic bracket B in which an arch wire AW has been placed. By downwardly forcing the plunger 24 into the dispenser 20, a clinician will thereby cause the last ligature system 10 in the stack 23 to be dispensed from the tube 22 and into the slot S. The clinician may thereafter apply further downward force directly onto the ligature system 10 in the slot S of the bracket B so as to further seat it therein and thereby positionally retain the arch wire AW. This procedure may then be repeated to dispense additional ligature systems 10 into respective additional slots S of brackets B as may be needed.

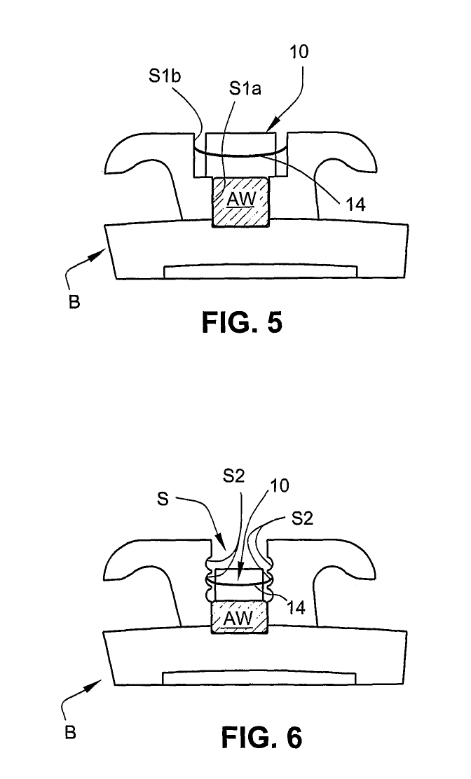

Alternative configurations for the slot S in a bracket B are depicted in accompanying FIGS. 5-8. In this regard, the slot S1 of FIG. 5 has an lower slot portion S1a which is relatively smaller in dimension as compared to the upper slot portion S1b. The lower slot portion S1a thus serves to receive an arch wire AW therein, while the upper slot portion S1b serves to receive a ligature system 10. FIG. 6 depicts a slot S in the bracket B which is formed with lateral serrations S2 in the side walls thereof. The serrations S2 thus serve to cooperate with the terminal retaining edges 14-1, 14-2 of the retaining plate 14 so as to securely position the ligature system 10 therewithin.

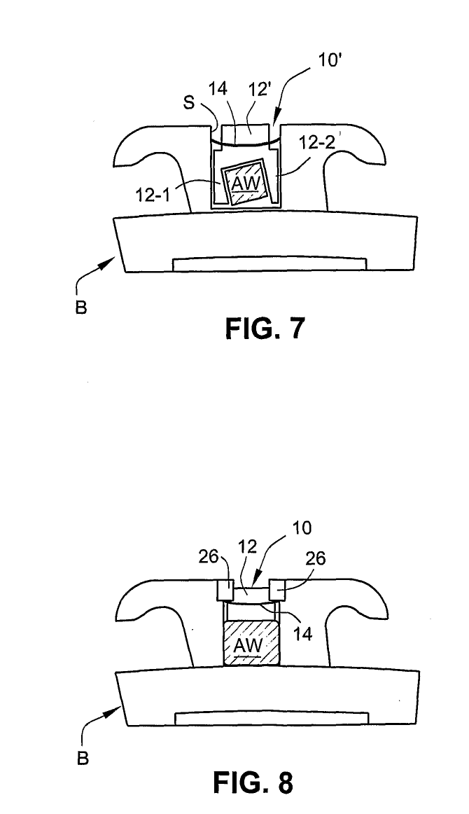

In the embodiment depicted in FIG. 7, the central block 12′ of ligature system 10′ includes a pair of downwardly projecting flanges 12-1, 12-2 which are sized and configured to sandwich the arch wire AW therebetween and thereby assist in the stabilization of the latter. Preferably, the space between the flanges 12-1, 12-2 is asymmetrical as depicted in FIG. 7 so as to impart a longitudinal twist to the arch wire AW positioned therein. Such a twisting force imparted to the arch wire AW will in turn impart a torsional force to the flanges 12-1, 12-2 which will assist in frictionally locking the central block 12′ within the bracket slot S. It is also envisioned that a symmetrical space may also be provided between the flanges 12-1, 12-2, but of course such an embodiment would not necessarily impart a beneficial twisting force to the arch wire AW positioned therein as described above.

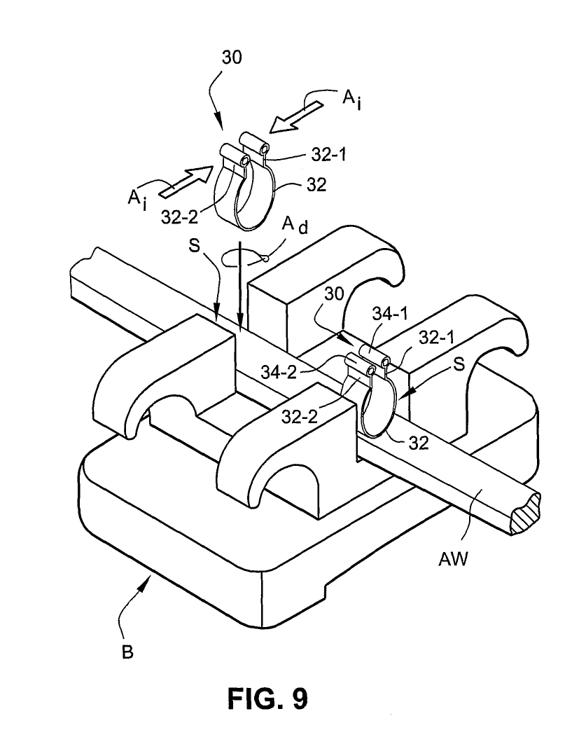

In FIG. 8, the bracket slot S is provided with a pair of generally U-shaped (as viewed in plan) retaining brackets 26 which serve to bound a portion of the central block 12 of the ligature system 10. As such, the retaining brackets 26 serve to prevent the movement of the ligature system 10 within the slot S along the lengthwise direction of the arch wire AW.

Although it is preferred that the retaining plate be concavely curved as depicted in FIGS. 1-3, other geometries are possible. Thus, for example, a generally V-shaped retaining plate could also be provided. In addition, the retaining plate may be in the form of a generally closed loop whose side edges engage with the sides of the slot S. Suffice it to say here, a skilled person in this art may select virtually any geometry so as to achieve unidirectional mechanical engagement between the retaining plate and the sides of the slot S in the manner described above.

Accompanying FIG. 9 depicts another embodiment of a ligature system 30 in accordance with the present invention. As shown, the ligature system 30 is most preferably in the form of a spring clip having a generally U-shaped retaining body portion 32 and upwardly oriented leg portions 32-1, 32-2. Tubular ends 34-1, 34-2 are connected to each of the leg portions 32-1, 32-2, respectively, to provide the clinician with a convenient means of handling the same (e.g., by means of suitable forceps if necessary).

As shown in FIG. 9, a clinician may apply inward pressure (arrows A₁) to each of the ends 34-1, 34-2 which will resiliently cause the retaining body portion 32 to dimensionally contract. While in such a dimensionally contracted state, the ligature system 30 may be inserted downwardly (arrow A_{d}) into the slot S of bracket B until the ligature system 30 is in contact with the arch wire AW therein. Releasing the applied inward pressure will then cause the retaining body portion 32 to resiliently expand dimensionally so as to exert pressure against the side walls of the slot S. In this manner, the ligature system 30 will be retained frictionally within the slot S of bracket B. When it is desired to remove the ligature system 30 from slot S, a clinician may simply repeat the procedure above. That is, inward pressure may be applied to the ends 34-1, 34-2 until the dimension of the body portion 32 is reduced sufficiently to allow it to be withdrawn from the slot S.

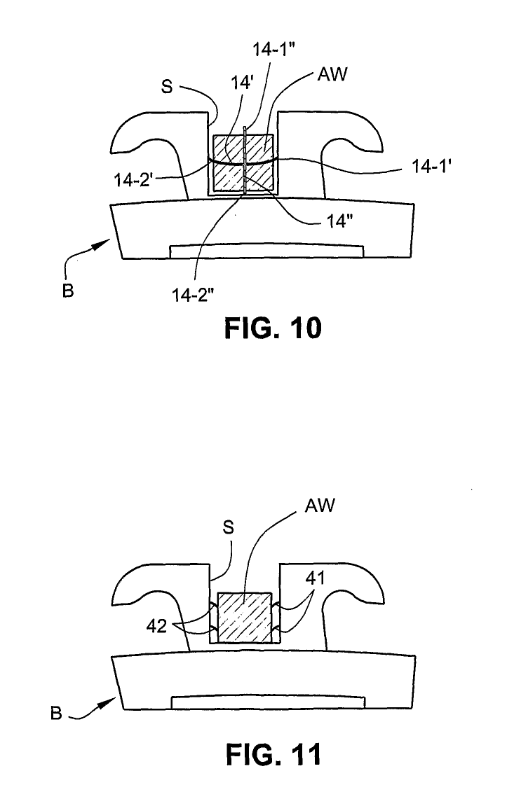

Accompanying FIGS. 10 and 11 depict further embodiments of the present invention. In this regard, according to the embodiment depicted in FIG. 10, a pair of generally mutually orthogonal retaining plates 14′, 14″ are formed integrally with the arch wire AW. Thus, the terminal ends 14-1′, 14-2′ of the retaining plate 14′ and the terminal ends 14-1″, 14-2″ of the retaining plate 14″ may extend outwardly from the arch wire AW to perform the same functions as the terminal ends 14-1, 14-2 associated with the retaining plate 14 described above in connection with FIGS. 1-2. As shown in FIG. 10, the ends 14-1′, 14-2′ are caused to curve upwardly and outwardly due to their being in frictional abutment with the side walls of the slot S.

According to the embodiment depicted in FIG. 11, the bracket B is integrally provided with pairs of retaining arms 41, 42 which extend inwardly and downwardly from the side walls of slot S. These pairs of retaining arms 41, 42 therefore serve to frictionally capture the arch wire AW when it is inserted downwardly in the slot S of bracket B.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

1. A ligature system to retain an arch wire within a slot of an orthodontic bracket comprising a retaining element which is capable of being unidirectionally mechanically locked within the slot of the orthodontic bracket to retain an arch wire therewithin.

2. The ligature system of claim 1, wherein the retaining element comprises a pair of generally opposed outwardly projecting retaining edges.

3. The ligature system of claim 2, wherein the retaining element comprises a planar retaining plate.

4. The ligature system of claim 2, wherein the retaining element comprises a curved retaining plate.

5. The ligature system of claim 2, further comprising a central block in which the retaining plate is embedded such that the retaining edges extend outwardly and upwardly therefrom.

6. The ligature system of claim 5, wherein the central block includes a pair of separated flanges defining therebetween a space for accepting an arch wire therein.

7. The ligature system of claim 6, wherein the space defined between the flanges is asymmetrical so as to induce a twisting force on the arch wire therein.

8. The ligature system of claim 1, further comprising a spike protruding outwardly therefrom.

9. The ligature system of claim 1, wherein the retaining element is integral with the arch wire.

10. The ligature system of claim 1, wherein the retaining element is integral with the slot in the orthodontic bracket.

11. The ligature system of claim 1, wherein the retaining element includes a generally U-shaped retaining portion.

12. The ligature system of claim 11, wherein the U-shaped retaining portion comprises terminal leg portions.

13. A ligature system for retaining an arch wire within a slot of an orthodontic bracket, the ligature system comprising a central block, and a pair of retaining edges outwardly extending from opposite sides of the central block.

14. The ligature system of claim 13, further comprising a retaining plate which includes the retaining edges, wherein a central portion of the retaining plate is embedded in the central block so that the retaining edges thereof extend outwardly therefrom.

15. The ligature system of claim 14, wherein the retaining element comprises a planar retaining plate.

16. The ligature system of claim 14, wherein the retaining plate is concavely curved.

17. The ligature system of claim 10, further comprising a spike extending outwardly from a bottom surface of the central block.

18. A dispenser for dispensing individual ligature systems, the dispenser comprising:
an elongate dispenser tube;
a stack of individual ligature systems within the dispenser tube, wherein each of the individual ligature systems comprise a central block, and a pair of retaining edges outwardly and upwardly extending from opposite sides of the central block; and a
plunger for exerting pressure on an uppermost one of the individual ligature systems in the stack within the dispenser tube to cause a lowermost one of the individual ligature systems to be expelled from the dispenser tube and into a slot of an orthodontic bracket.

19. A method of securing an arch wire within a slot of an orthodontic bracket comprising forcing a ligature system as in claim 1 into the slot of the orthodontic bracket in which the arch wire is positioned and allowing the ligature system to be unidirectionally locked within the slot so as to retain the arch wire therein.

20. The method as in claim 19, further comprising aligning a ligature system dispenser with the slot, the dispenser comprising a stack of individual ligature systems, and thereafter causing an individual one of the ligature systems to be dispensed from the dispenser into the slot.

21. The method as in claim 20, comprising applying downward pressure to an uppermost one of the individual ligature systems in the dispenser sufficient to cause a lowermost one of the individual ligature systems in the dispenser to be dispensed therefrom into the slot.
